(19) United States
(12) Patent Application Publication
(10) Pub. No.: US 2024/0119112 A1
(43) Pub. Date: Apr. 11, 2024

(54) Tomography of unitary matrix using quantum computing device

(71) Applicant: Microsoft Technology Licensing, LLC, Redmond, WA (US)

(72) Inventors: Jeongwan HAAH, Bellevue, WA (US); Robin Ashok KOTHARI, Seattle, WA (US); Ryan William O'DONNELL, Pittsburgh, PA (US); Ewin Nicolas TANG, Seattle, WA (US)

(73) Assignee: Microsoft Technology Licensing, LLC, Redmond, WA (US)

(21) Appl. No.: 17/934,322

(22) Filed: Sep. 22, 2022

(51) Int. Cl. G06F 17/16; G06N 10/20

(52) U.S. Cl. CPC G06F 17/16; G06N 10/20

(57) ABSTRACT

A computing system including a quantum computing device and a classical computing device. The computing system computes an estimated unitary matrix over a plurality of iterations that each include, at a processor, computing a current-iteration exponent, a current-iteration error parameter, and a conjugate transpose of a current-iteration estimate of the unitary matrix. Each iteration further includes transmitting the current-iteration exponent, the current-iteration error parameter, and the conjugate transpose to the quantum computing device. At the quantum computing device, each iteration further includes computing a process tomography result and outputting the process tomography result to the classical computing device. At the processor, each iteration further includes computing a distance measure between the current-iteration estimate and the process tomography result, and, when the distance measure is below a predefined constant, updating the current-iteration estimate. The computing system outputs, as the estimated unitary matrix, the updated current-iteration estimate computed in a final iteration.

### BACKGROUND

During the development of quantum computing devices and implementation of quantum algorithms on those quantum computing devices, it is frequently useful to test the functionality of different computing pipeline components. The computing pipeline components on which tests are performed may include the quantum computing device, a classical computing device coupled to the quantum computing device, and portions of those devices. For example, a test may be performed to determine a location in the pipeline at which an error has occurred. The results of such a test may, for example, allow a developer to distinguish between hardware malfunctions at the quantum computing device and software errors in downstream processing at the classical computing device.

### SUMMARY

According to one aspect of the present disclosure, a computing system is provided, including a quantum computing device. The computing system further includes a classical computing device including a processor. The computing system computes an estimated unitary matrix over a plurality of iterations that each include, at the processor, computing a current-iteration exponent and a current-iteration error parameter for a current iteration of the plurality of iterations. Each iteration further includes computing a conjugate transpose of a current-iteration estimate of the unitary matrix. Each iteration further includes transmitting the current-iteration exponent, the current-iteration error parameter, and the conjugate transpose of the current-iteration estimate to the quantum computing device. At the quantum computing device, each iteration further includes computing a process tomography result based at least in part on the current-iteration exponent, the current-iteration error parameter, the conjugate transpose of the current-iteration estimate, and the unitary matrix. Each iteration further includes outputting the process tomography result to the classical computing device. At the processor, each iteration further includes computing a distance measure between the current-iteration estimate and the process tomography result. When the distance measure is below a predefined constant, each iteration further includes updating the current-iteration estimate based at least in part on the process tomography result. The computing system outputs, as the estimated unitary matrix, the updated current-iteration estimate computed in a final iteration of the plurality of iterations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system, including a quantum computing device and a classical computing device, at which an estimated unitary matrix is computed, according to one example embodiment.

FIG. 2A shows example pseudocode of a unitary matrix estimation algorithm that may be executed at the computing system, according to the example of FIG. 1.

FIG. 2B schematically shows an iteration of the unitary matrix estimation algorithm, according to the example of FIG. 2A.

FIG. 3 schematically shows a process tomography algorithm that may be executed during computation of the estimated unitary matrix, according to the example of FIG. 2A.

FIG. 4 schematically shows a first initial state that may be stored in registers of the quantum computing device when estimated eigenvalues of the unitary matrix are computed, according to the example of FIG. 1.

FIG. 5 schematically shows the computing system during estimation of a phase difference between two eigenvalues of the unitary matrix, according to the example of FIG. 4.

FIG. 6 schematically shows the computing system during estimation of a plurality of eigenvalues of the unitary matrix, according to the example of FIG. 5.

FIG. 7A shows a flowchart of a method for use with a computing system to compute an estimated unitary matrix, according to the example of FIG. 1.

FIG. 7B shows additional steps of the method of FIG. 7A that may be performed when a process tomography result is computed.

FIG. 8A shows a flowchart of a method for use with a computing system to compute a plurality of eigenvalues of a unitary matrix, according to the example of FIG. 1.

FIG. 8B shows additional steps of the method of FIG. 8A that may be performed in some examples when computing a plurality of estimated phase differences.

FIG. 9 shows a schematic view of an example computing environment in which the computing system of FIG. 1 may be instantiated.

### DETAILED DESCRIPTION

When testing and debugging a computing pipeline that includes a quantum computing device, it is sometimes desirable to compute an estimate of an unknown unitary matrix. An unknown unitary matrix may, for example, be estimated in order to identify an operator applied by a quantum circuit included in the quantum computing device. By comparing the estimate of the unitary matrix to a theoretically expected value of that unitary matrix, the developer of the quantum computing device may determine whether the quantum circuit is functioning properly.

Unitary matrix estimation also has other uses in quantum computing beyond quantum circuit testing and debugging. Quantum phase estimation is an algorithm by which the phase of an eigenvalue of a unitary operator may be computed given a unitary matrix and a quantum state. Some other quantum algorithms, such as Shor's algorithm and the quantum algorithm for solving systems of linear equations, use quantum phase estimation as a subroutine. However, conventional quantum phase estimation relies on being able to apply a controlled version of the unitary matrix, and it may be desirable to perform quantum phase estimation in some instances in which the controlled unitary matrix is not available. Techniques for estimating unitary matrices that do not require controlled versions of those unitary matrices may be useful as alternatives to conventional quantum phase estimation in such instances.

The problem of unitary matrix estimation may be posed as follows. Black-box applications of a unitary matrix U∈U(d) are assumed to be performable, where d is a dimension greater than or equal to 1 and U(d) is the set of d×d unitary matrices. In addition, the ability to apply quantum circuits of space n≥log₂(d) is assumed. When a quantum circuit of space n is applied, the input to the quantum circuit is given as V₀, V₁, . . . , Vₖ∈U(2ⁿ). U is padded to be included in U(2ⁿ) in the input of the quantum circuit. The output of the quantum circuit is given by VₖU . . . UV₁UV₀|1 [symbol] measured in the computational basis |1 [symbol] , . . . , |d [symbol] . The unitary matrix estimation problem is the problem of, for error parameters ε, δ∈(0,1), outputting a unitary matrix estimate Ũ∈U(d) such that dist_{PU}(Ũ, U)<ε with a probability>1−δ. In the above problem statement, the distance between Ũ and U is defined as:

$${dist}_{PU} ( U , V ) = {min}_{ϕ ∈ U ( 1 )} ‖ ϕ U - V ‖$$

where U(1) is the complex unit circle and ∥⋅∥ denotes the largest singular value of a matrix.

Using the techniques discussed in further detail below, given an unknown unitary matrix U, a unitary matrix estimate Ũ∈U(d) may be generated such that dist_{PU}(Ũ, U)<ε with probability>1−δ using O(d²/ε) queries to U (with dependence of the query complexity on δ treated as a constant factor). The unitary matrix estimate Ũ may be computed with ┌log₂(d)┐ qubits. The techniques discussed herein may achieve a significant reduction in space usage over prior unitary matrix estimation algorithms, since prior algorithms perform O(d²/\sqrt{ε}) queries to U in parallel.

In examples in which the unitary matrix U may be applied to obtain U|0 [symbol] =|ψ [symbol] , where |ψ [symbol] is an eigenvector of U, the techniques discussed herein further allow |ψ [symbol] to be estimated using O(1/ε) uses of U for a fixed value of d. Such techniques do not require applying the inverse of U. Previous work on the problem of estimating |ψ [symbol] found that in examples in which copies of |ψ [symbol] are available, estimating the value of |ψ [symbol] has a query complexity of O(1/ε²). As another earlier result, a circuit that prepares |ψ [symbol] , as well as the ability to apply the inverse and control of such a circuit, allow |ψ [symbol] to be estimated with O(1/ε) query complexity using amplitude amplification. However, such prior approaches do not allow |ψ [symbol] to be estimated with O(1/ε) query complexity without the inverse or control of the quantum circuit that generates |ψ [symbol] . The techniques discussed below therefore allow for estimation of |ψ [symbol] with O(1/ε) query complexity and with fewer requirements than previous approaches.

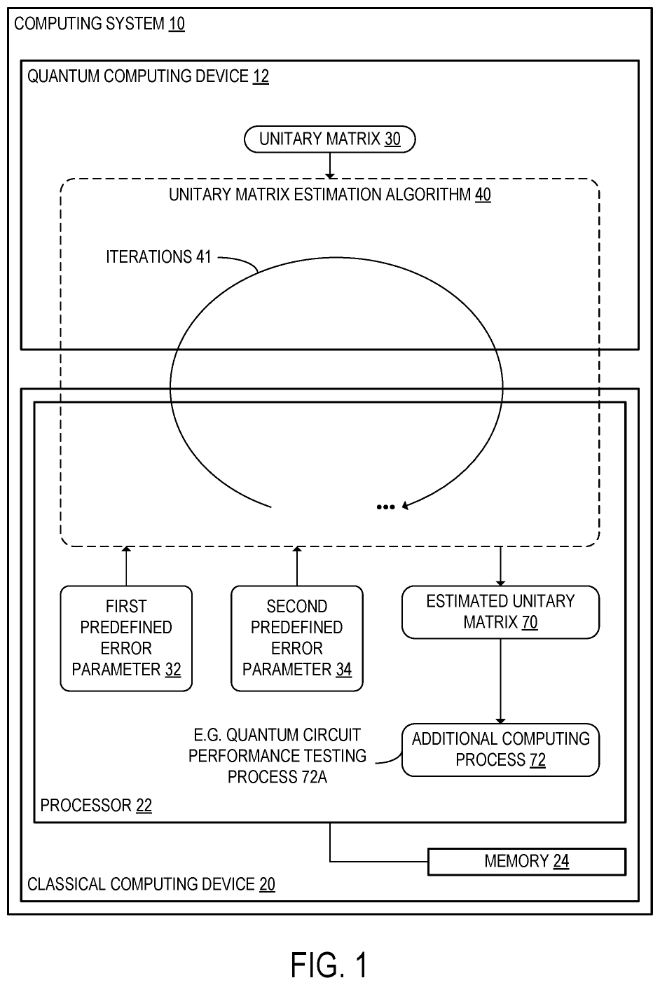

FIG. 1 schematically shows a computing system 10 including a quantum computing device 12 and a classical computing device 20, according to one example. At the quantum computing device 12, a plurality of qubits are instantiated at a qubit encoding surface. The quantum computing device 12 may include a plurality of logical qubits that are each formed from a respective plurality of physical qubits. The plurality of physical qubits that form each logical qubit may be used to encode the state of the logical qubit and perform quantum error correction. At the quantum computing device 12, gates and measurements are performed on the logical qubits to perform quantum computations. The quantum computing device 12 may, for example, be a topological quantum computing device.

The classical computing device 20 shown in FIG. 1 includes a processor 22. The classical computing device 20 of FIG. 1 further includes memory 24 that is communicatively coupled to the processor 22. The classical computing device 20 is configured to receive measurement results from the quantum computing device 12 and perform further computations on those measurement results at the processor 22. In some examples, the quantum computing device 12 may also receive control inputs from the classical computing device 20. Thus, some computations that would be inefficient to perform at the classical computing device 20 may be offloaded to the quantum computing device 12.

As shown in the example of FIG. 1, the computing system 10 computes an estimated unitary matrix 70 that approximates a unitary matrix 30 implemented at the quantum computing device 12. The estimated unitary matrix 70 is computed at a unitary matrix estimation algorithm 40 over a plurality of iterations 41. As depicted in the example of FIG. 1, the unitary matrix estimation algorithm 40 includes portions that are performed at the quantum computing device 12 and portions that are performed at the processor 22 of the classical computing device 20. The unitary matrix estimation algorithm 40 may additionally receive a first predefined error parameter 32 and a second predefined error parameter 34 as input in some examples.

Subsequently to performing the unitary matrix estimation algorithm 40, the computing system 10 outputs the estimated unitary matrix 70 to an additional computing process 72. In some examples, the additional computing process is a quantum circuit performance testing process 72A. In such examples, the unitary matrix 30 may be an operator implemented by a portion of the quantum computing device 12 that is under test. The quantum circuit performance testing process 72A may, in such examples, determine whether the estimated unitary matrix 70 matches an expected unitary matrix in order to determine whether the tested quantum circuit is functioning as intended.

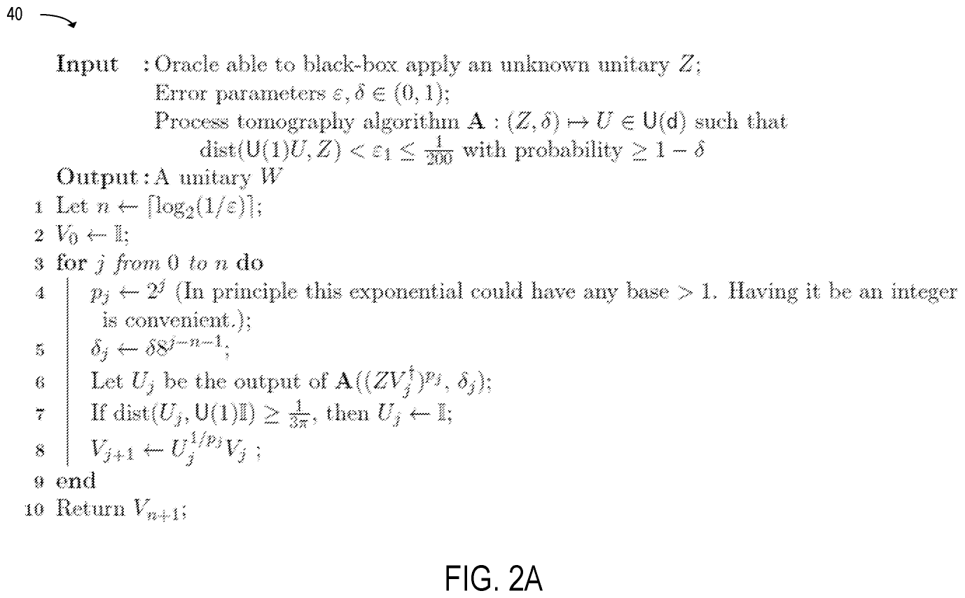

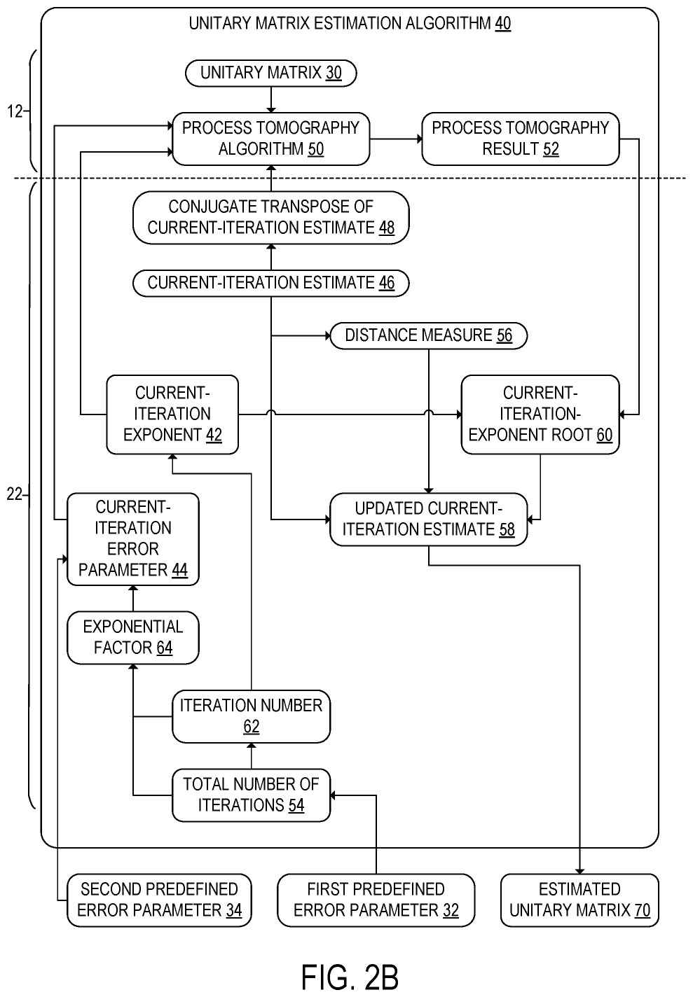

FIG. 2A shows example pseudocode of the unitary matrix estimation algorithm 40. In addition, FIG. 2B schematically shows data flow within the unitary matrix estimation algorithm 40 during an iteration 41. The computations shown above the dotted line in FIG. 2B are performed at the quantum computing device 12, and the computations shown below the dotted line are performed at the processor 22.

As shown in FIGS. 2A-2B, the inputs to the unitary matrix estimation algorithm 40 include the unitary matrix 30 implemented at the quantum computing device 12 and a first predefined error parameter 32 and a second predefined error parameter 34. The first predefined error parameter 32 and the second predefined error parameter 34 are indicated as ϵ, δ∈(0,1) in FIG. 2A.

In addition, as discussed in further detail below, the inputs to the unitary matrix estimation algorithm 40 further include a process tomography algorithm 50 performed at the quantum computing device 12. The process tomography algorithm 50 is shown in FIG. 2A as having the type signature A: (Z, δ) [symbol] U∈U(d), where Z is the unitary matrix 30 and δ is the second predefined error parameter. In addition, as shown in FIG. 2A, the process tomography algorithm 50 has error ε₁ such that

$$dist ( U ( 1 ) U , Z ) < {ε}_{1} \leq \frac{1}{200}$$

with probability greater than or equal to 1−δ. In the above inequality, U(1) is the complex unit circle. The distance dist is between two points in U(d) is given by the infimum of the lengths of all smooth paths connecting the points:

dist(U,V)=inf∫₀¹∥γ′(t)∥dt

where γ: [0,1]→U(d) is a smooth path such that γ(0)=U and γ(1)=V.

During setup of the unitary matrix estimation algorithm 40, prior to the plurality of iterations, the processor 22 computes a total number of the plurality of iterations 54 based at least in part on the first predefined error parameter 32, according to the example of FIGS. 2A-2B. As shown in FIG. 2A, the total number of iterations 54 may be given by n=┌log₂(1/ε)┐. During the setup, the processor 22 may also initialize a current-iteration estimate 46 of the estimated unitary matrix 70 as a d×d identity matrix [symbol] .

During each iteration 41 of the unitary matrix estimation algorithm 40, the processor 22 computes a current-iteration exponent 42 and a current-iteration error parameter 44 for a current iteration 41 of the plurality of iterations 41. In the example of FIGS. 2A-2B, the current-iteration exponent 42 and the current-iteration error parameter 44 are computed based at least in part on an iteration number 62 of the current iteration 41. The current-iteration exponent 42, as shown in the example of FIG. 2A, is computed as two to the power of the iteration number 62 of the current iteration 41, such that pⱼ=2^{j} for the jth iteration. In other examples, some base other than 2 may be used when computing the current-iteration exponent 42.

The current-iteration error parameter 44 may, as shown in FIG. 2A, be computed as a product of the second predefined error parameter 34 and an exponential factor 64. The exponential factor 64 may be computed based at least in part on the iteration number 62 and the total number of the plurality of iterations 54. In the example of FIG. 2A, the current-iteration error parameter 44 is given by of δⱼ=δ8^{j-n-1}.

During each iteration 41, the processor 22 is further configured to compute a conjugate transpose of the current-iteration estimate 48 of the unitary matrix 30. The conjugate transpose of the current-iteration estimate 48 is expressed as Vⱼ^{†} in FIG. 2A.

The processor 22 further transmits the current-iteration exponent 42, the current-iteration error parameter 44, and the conjugate transpose of the current-iteration estimate 48 to the quantum computing device 12. The current-iteration exponent 42, the current-iteration error parameter 44, and the conjugate transpose of the current-iteration estimate 48 may be stored at qubit registers of the quantum computing device 12.

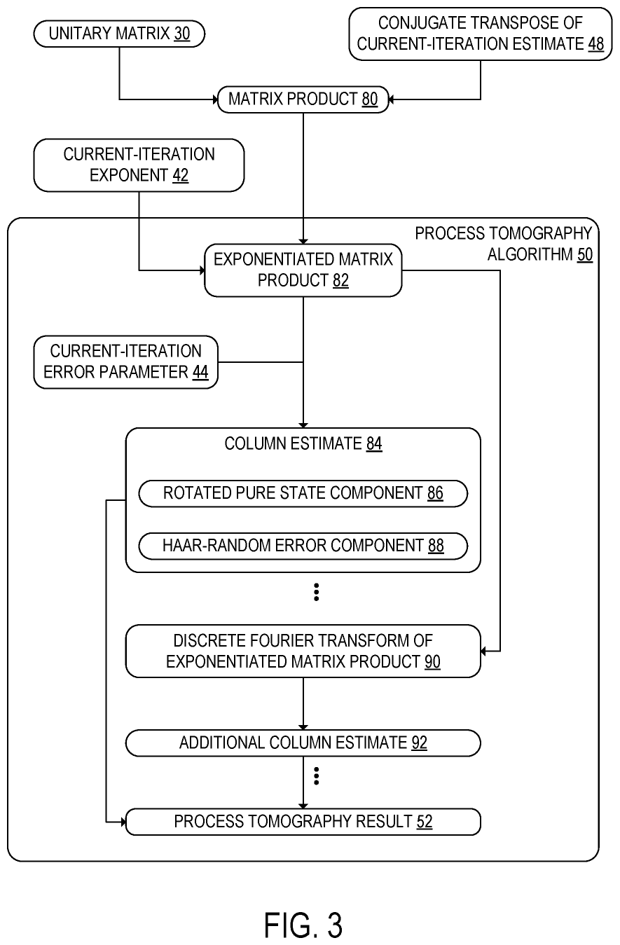

The quantum computing device 12 executes a process tomography algorithm 50 that outputs a process tomography result 52. The process tomography algorithm 50 computes the process tomography result 52 based at least in part on the current-iteration exponent 42, the current-iteration error parameter 44, the conjugate transpose of the current-iteration estimate 48, and the unitary matrix 30. FIG. 3 shows the process tomography algorithm 50 and its inputs in further detail. Computing the process tomography result 52, as depicted in FIG. 3, includes computing a matrix product 80 of the unitary matrix 30 and the conjugate transpose of the current-iteration estimate 48. Computing the process tomography result 52 further includes raising the matrix product to the current-iteration exponent 42 to obtain an exponentiated matrix product 82. The process tomography result 52 is computed by executing the process tomograph algorithm 50 with the exponentiated matrix product 82 and the current-iteration error parameter 44 as input. As shown in FIG. 2A, the process tomography result 52 may be computed as Uⱼ=A((ZVⱼ^{†})^{p}^{ⱼ}, δⱼ).

When the quantum computing device 12 performs the process tomography algorithm 50, the quantum computing device 12 may perform a plurality of von Neumann measurements on a respective plurality of copies of a pure state |u [symbol] ∈ [symbol] ^{d}. The pure state |u) is a column of the exponentiated matrix product 82 in the example of FIG. 3. The number of von Neumann measurements may be given by

$$O ( \frac{d}{{ε}_{1}^{2}} log ( 1 / {δ}_{j} ) ) .$$

Treating d and ε₁ as constants results in a complexity of O(log(1/δⱼ)) for the number of von Neumann measurements. The quantum computing device 12 subsequently outputs, to the classical computing device 20, a process tomography result 52 including a plurality of column estimates 84 computed as measurement outcomes of the von Neumann measurements. The von Neumann measurements may be performed in d-dimensional Hilbert space, such that each column estimate 84 is expressed with n qubits when d=2ⁿ.

Each of the column estimates 84 may include a rotated pure state component 86 and a Haar-random error component 88. The column estimates 84 may each be expressed as:

|û [symbol] =ϕ\sqrt{1−ε₂}|u [symbol] +\sqrt{ε₂}|w

[symbol]

In the above equation, ϕ is a complex phase and |w [symbol] is a vector sampled from a Haar-random distribution of states orthogonal to the pure state |u [symbol] . ε₂ is an infidelity of the column estimate 84 that is upper bounded by δⱼ except with a probability of e^{-5d}.

The column estimates 84 form the columns of an estimate V of the exponentiated matrix product 82. The estimate V satisfies the inequality

$${min}_{ϕ ∈ U ( 1 )} ‖ {( {ZV}_{j}^{†} )}^{{p}_{j}} - ϕ V ‖ \leq ε$$

except with a probability of at most δ, where U is the estimated unitary matrix 30, ε is the first predefined error parameter 32, and δ is the second predefined error parameter 34. In addition, the process tomography algorithm 50 applies U a number of times given by O(d²/ε²)·log(1/δ).

Each of the column estimates 84 may have a different complex phase ϕ. However, the computing may correct for the complex phases ϕ. Correcting for the complex phases ϕ may include multiplying the exponentiated matrix product 82 by a discrete Fourier transform operator F∈U(d) to obtain a discrete Fourier transform of the exponentiated matrix product 90. The discrete Fourier transform operator is given by:

$$〈 a \vert F \vert 〉 = \frac{1}{\sqrt{d}} {e}^{- 2 π iab / d}$$

The discrete Fourier transform of the exponentiated matrix product 90 may be expressed as (ZVⱼ^{†})^{p}^{ⱼ}F. In examples in which d=2ⁿ, a Hadamard transform H^{⊗n} may be used as an alternative to the Fourier transform. In addition, correcting for the complex phases may further include generating column estimates of (ZVⱼ^{†})^{p}^{ⱼ}F using the steps by which the column estimates 84 are generated. The process tomography estimate matrix generated from (ZVⱼ^{†})^{p}^{ⱼ}F is denoted G∈U(d) and includes, as its columns, a plurality of additional column estimates 92.

The quantum computing device 12 transmits the columns of G to the processor 22. Subsequently to receiving the columns of G from the quantum computing device 12, the processor 22 further generates diagonal unitary matrices Ψ_{V} and Ψ_{G} such that the inequality ∥V^{†}G−Ψ_{V}^{†}FΨ_{G}∥ₒₚ≤2ε is satisfied. In this inequality, ∥⋅∥ₒₚ is an operator norm. The estimate V corrected for the complex phases ϕ of the column estimates 84 is given by VΨ_{V}^{†}. Thus, the processor 22 performs respective rotational corrections on the column estimates 84 based at least in part on the plurality of additional column estimates 92.

The diagonal unitary matrices Ψ_{V} and Ψ_{G} may be computed based at least in part on the matrices V^{†}G and F, which are explicitly known. The entries of V^{†}G and F differ by a phase shift that may be computed using the positions of the entries in the matrices V^{†}G and F. The first column and first row of F, which include entries that are all positive and real-valued, may be compared to the first column and first row of V^{†}G, which may include complex-valued entries, to compute the phase shift between V^{†}G and F. The processor 22 may then generate a pair of diagonal unitary matrices Ψ_{V} and Ψ_{G} that apply the phase shift to F.

Returning to FIGS. 2A-2B, subsequently to receiving the process tomography result 52 including the column estimates 84, the processor 22 further computes a distance measure 56 between the current-iteration estimate 46 and the process tomography result 52. As shown in the example of FIG. 2A, the distance measure 56 is computed using the dist function defined above, such that the distance measure 56 is computed as dist(Uⱼ, U(1) [symbol] ). When the distance measure 56 is below a predefined constant, the processor 22 updates the current-iteration estimate 46 based at least in part on the process tomography result 52. The predefined constant is equal to ⅓π in the example of FIG. 2A. dist(Uⱼ, U(1) [symbol] )=⅓π is equivalent to the statement that all the eigenvalues of Uⱼ are coverable on the complex unit circle by an arc of length of ⅔π.

As shown in the example of FIG. 2A, when the distance measure 56 is greater than or equal to the predefined constant, the processor 22 replaces the process tomography result 52 with an identity matrix, thereby setting Uⱼ= [symbol] . Subsequently to checking whether the distance measure 56 is below the predefined constant, the processor further computes an updated current-iteration estimate 58 as Vⱼ₊₁=Uⱼ^{1/p}^{ⱼ}Vⱼ. Thus, in examples in which the distance measure 56 is greater than or equal to the predefined constant and the process tomography result 52 is replaced with the identity matrix, the updated current-iteration estimate 58 is unchanged relative to the current-iteration estimate 46. When the distance measure 56 is instead below the predefined constant and the process tomography result 52 is not replaced with the identity matrix, updating the current-iteration estimate 46 includes multiplying the current-iteration estimate 46 by a current-iteration-exponent root 60 of the process tomography result 52. The updated current-iteration estimate 58 may be used as the current-iteration estimate 46 in a subsequent iteration 41.

The current-iteration estimate 46 is iteratively updated over the plurality of iterations 41 of the unitary matrix estimation algorithm 40. When the plurality of iterations 41 have been completed, the processor 22 outputs, as the estimated unitary matrix 70, the current-iteration estimate 46 computed in a final iteration 41 of the plurality of iterations 41.

The estimated unitary matrix 70 computed using the techniques discussed above is within a diamond-norm distance ε (the first predefined error parameter 32) of the unitary matrix 30 with a probability of 1−δ (where (is the second predefined error parameter 34). The diamond norm is defined by the following equation:

$${‖ Φ ‖}_{⋄} = {max}_{X ; {‖ X ‖}_{1} \leq 1} {‖ ( Φ ⊗ {1}_{n} ) X ‖}_{1}$$

In the above equation, Φ: Mₙ( [symbol] )−Mₘ( [symbol] ) is a linear transformation, where Mₙ( [symbol] ) is the space of n×n complex matrices, 1ₙ: Mₙ( [symbol] )→Mₙ( [symbol] ) is the identity map, X∈Mₙ_{²}(C), and ∥⋅∥₁ is the trace norm. The diamond norm may be used as a measure of distinguishability between the unitary matrix 30 and the estimated unitary matrix 70.

The unitary matrix estimation algorithm 40 presented above has a sample complexity of

$$O ( \frac{{d}^{2}}{ε} log \frac{1}{δ} )$$

where Q is the sample complexity of the process tomography algorithm 50. The sample complexity of the process tomography algorithm 50 is Q=d² (up to a constant factor of 1/ε₂²), thereby resulting in an overall sample complexity of

$$O ( \frac{Q}{ε} log \frac{1}{δ} ) ,$$

for the unitary matrix estimation algorithm 40.

In some examples, additionally or alternatively to computing the estimated unitary matrix 70, the computing system 10 may be configured to estimate a plurality of eigenvalues of the unitary matrix 30. Similarly to computing the estimated unitary matrix 70, the computing system 10 may compute the estimated eigenvalues without requiring an inverse or controlled version of the unitary matrix 30.

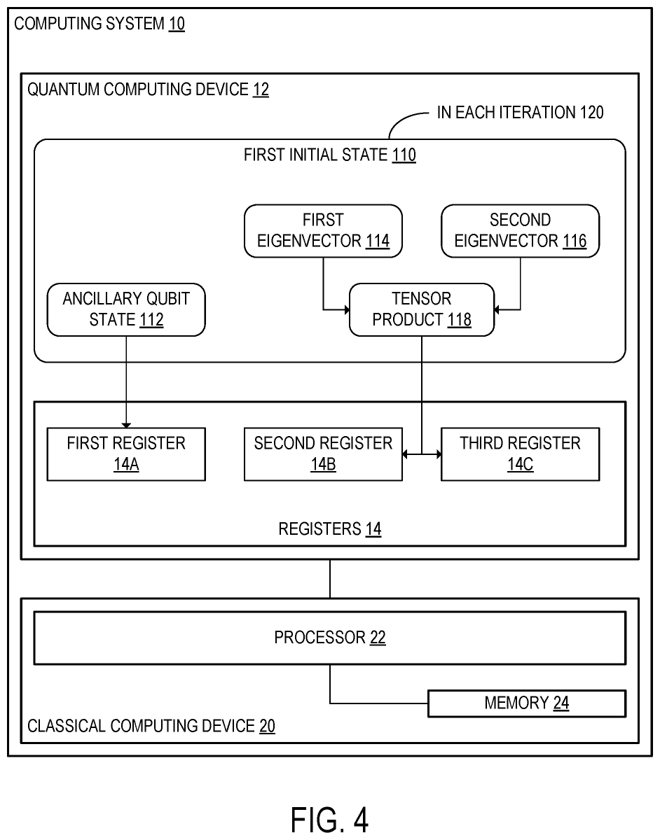

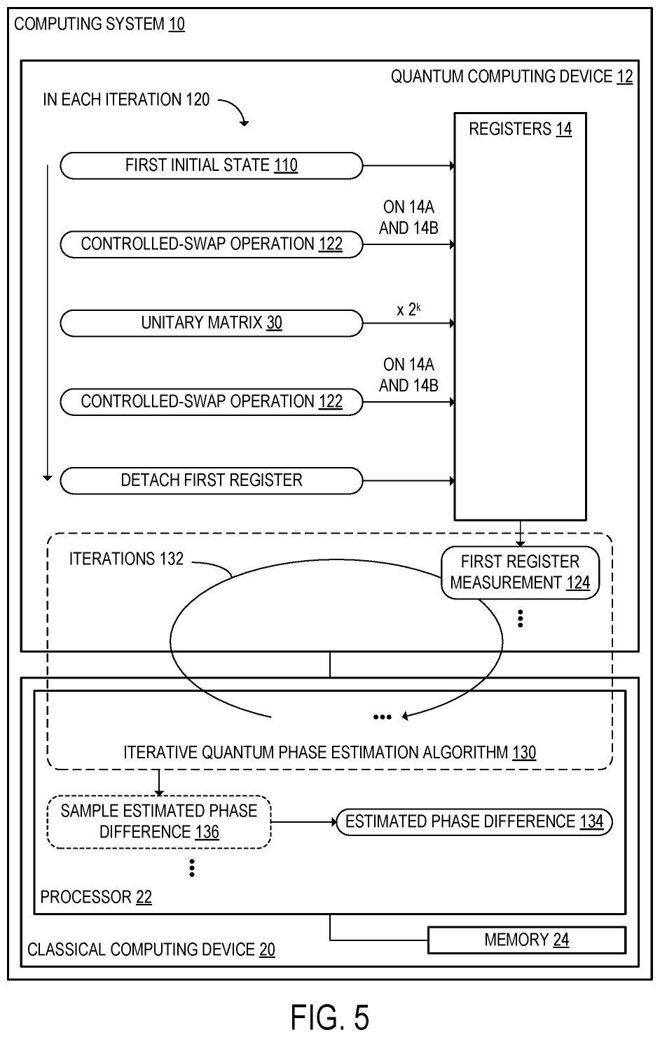

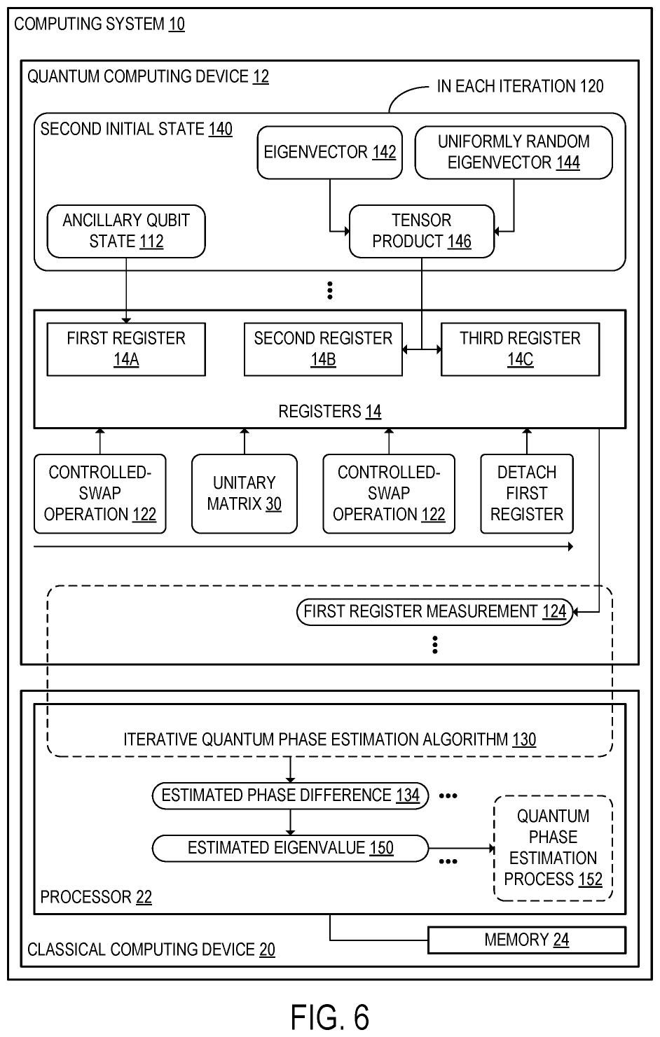

FIG. 4 shows a first initial state 110 that is stored in registers 14 of the quantum computing device 12 and used when estimating the eigenvalues of the unitary matrix 30. The first initial state 110 is used to estimate a phase difference between two eigenvalues, as discussed in further detail below with reference to FIG. 5. By applying the phase difference determination technique discussed below to a first eigenvector 114 of the unitary matrix 30 and a uniformly random mixture of the eigenvectors of the unitary matrix 30, a phase difference associated with the first eigenvector 114 is estimated, as discussed in further detail below with reference to FIG. 6. Estimated eigenvalues may then be computed based at least in part on the phase differences.

As shown in the example of FIG. 4, the first initial state 110 is stored across a first register 14A, a second register 14B, and a third register 14C, each of which may include a respective plurality of qubits. Respective first initial states 110 may be prepared at the quantum computing device 12 in each of a plurality of iterations 120 over which the eigenvalue is estimated. Preparing the first initial state 110 includes, at the quantum computing device 12, receiving an ancillary qubit state 112 at the first register 14A. For example, the ancillary qubit state may be a |+ [symbol] state. In addition, preparing the first initial state 110 further includes receiving a tensor product 118 of a first eigenvector 114 of the unitary matrix 30 and a second eigenvector 116 of the unitary matrix 30. The tensor product 118 may be denoted as |a [symbol] ⊗|b [symbol] , where |a [symbol] and |b [symbol] are the first eigenvector 114 and the second eigenvector 116, respectively. The tensor product 118 is received at the second register 14B and the third register 14C of the quantum computing device 12 such that the respective states of the second register 14B and the third register 14C are entangled.

FIG. 5 shows the computation of an estimated phase difference 134 between the first eigenvector 114 and the second eigenvector 116 over the plurality of iterations 120. Subsequently to preparing the first initial state 110, computing the estimated phase difference 134 further includes, at the quantum computing device 12, performing a controlled-SWAP operation 122 on the second register 14B and the third register 14C. The controlled-SWAP operation 122 is controlled on the first register 14A.

Subsequently to applying the controlled-SWAP operation, the quantum computing device 12 applies the unitary matrix 30 to the second register 14B a number of times determined based at least in part on an iteration number of a current iteration 120. As shown in the example of FIG. 5, the number of times the unitary matrix 30 is applied to the second register 14B may be equal to two to the power of the iteration number, where the iteration number starts at 0. Thus, in the kth iteration, an operator U²^{^{k}} is performed on the second register 14B.

Subsequently to the one or more unitary matrix operations performed on the second register 14B, the quantum computing device 12 further repeats the controlled-SWAP operation 122 on the second register 14B and the third register 14C, controlled on the first register 14A.

After repeating the controlled-SWAP operation 122, the quantum computing device 12 detaches the first register 14A from the second register 14B and the third register 14C. Subsequently to detaching the first register 14A from the second register 14B and the third register 14C, the second register 14B and the third register 14C store the tensor product 118 of the first eigenvector 114 and the second eigenvector 116. Thus, the tensor product 118 included in the first initial state 110 is already prepared for a subsequent iteration 120.

In examples in which the ancillary qubit state 112 included in the first initial state 110 is a |+ [symbol] state, the first register 14A has the state \sqrt{½}(e^{iα}|0 [symbol] +e^{iβ}|1 [symbol] ). In the above expression, α, β∈[0,2π) are the respective eigenphases of the eigenvectors |a [symbol] and |b [symbol] , where e^{iα} is the eigenvalue corresponding to |a [symbol] and e^{iβ} is the eigenvalue corresponding to |b [symbol] . Up to a global phase, the state stored in the first register 14A is equal to \sqrt{½}(|0 [symbol] +e^{i(β-α)}|1 [symbol] ). The state of the first register 14A after the kth iteration is therefore given by \sqrt{½}(|0 [symbol] +eⁱ²^{^{k}}^{(β-α)}|1 [symbol] ) up to a global phase for all 0≤k<m, where m is the total number of iterations 120. The total number of uses of the unitary matrix U is equal to 2^{m-1}.

Subsequently to performing the plurality of iterations 120 in which the controlled-SWAP operations 122 and the unitary matrix multiplications are performed and the first register is detached, the processor 22 and the quantum computing device 12 perform iterative quantum phase estimation on the first register 14A. Iterative quantum phase estimation is performed at an iterative quantum phase estimation algorithm 130 executed at the quantum computing device 12 and the processor 22 over a plurality of iterations 132. At the iterative quantum phase estimation algorithm 130, classically controlled phase gates are iteratively applied to the ancillary qubit state 112. Since control of the second register 14B and the third register 14C is provided by the controlled-SWAP operations 122, the iterative quantum phase estimation algorithm 130 does not require controlled U operations. When the iterative quantum phase estimation algorithm 130 is performed, a plurality of first register measurements 124 of the state of the first register 14A may be made in order to read out bits of the estimated phase difference 134. The iterative quantum phase estimation algorithm 130 outputs an estimated phase difference 134 between the first eigenvector 114 and the second eigenvector 116, which may be expressed as β−α. Performing iterative quantum phase estimation may allow the estimated phase difference 134 to be computed with one additional qubit beyond the qubits used in the plurality of iterations 120.

In some examples, the computing system 10 repeats the computation of the estimated phase difference 134 multiple times to increase the accuracy of the estimate. In such examples, the computing system 10 computes a plurality of sample estimated phase differences 136 using the iterative quantum phase estimation algorithm 130. The computing system 10 further computes the estimated phase difference 134 as a median of the plurality of sample estimated phase differences 136.

The computation of the estimated phase difference 134 returns a result within ±ε of β−α with a probability of at least 1−δ, for a pair of predefined error parameters ε, δ>0. In addition, the estimated phase difference 134 may be computed with O(log(1/δ)/ε) or fewer applications of U. These error bounds may be achieved by computing the estimated phase difference 134 as the median of log(1/δ) sample estimated phase differences 136.

The quantum computing device 12 and the processor 22 further utilize the estimated phase difference computation technique shown in FIG. 5 to estimate the eigenvalues of the unitary matrix 30. The computation of a plurality of estimated eigenvalues 150 is schematically shown in FIG. 6, according to one example. In the example of FIG. 6, the quantum computing device 12 adjoins the eigenvector 142, which is denoted as |a [symbol] and stored in the second register 14B, to a uniformly random eigenvector 144, which is denoted as |b [symbol] and stored in the third register 14C. Thus, the uniformly random eigenvector 144 is used in place of the second eigenvector |b [symbol] in a second initial state 140. The uniformly random eigenvector 144 is a maximally mixed state of each of the eigenvectors of the unitary matrix 30.

When |a [symbol] ⊗|b [symbol] is stored in the second register 14B and the third register 14C, the estimated phase difference 134 computed as the output of the iterative quantum phase estimation algorithm 130 is an estimate of β−α, where α and β are the respective eigenphases of the eigenvector |a) and the uniformly random eigenvector |b [symbol] . The quantum computing device 12 and the processor 22 may compute a plurality of estimated phase differences 134 for different eigenvectors of the unitary matrix 30, using the same uniformly random eigenvector 144 in each of the phase difference estimations. Thus, the same eigenphase β may be approximated in each of the phase difference approximations, while the value of α may have different estimated values for the different eigenvectors. The computed estimates of β−α may therefore be different for distinct eigenvalues of the unitary matrix 30.

Subsequently to the computation of the plurality of estimated phase differences 134, the processor 22 computes a plurality of estimated eigenvalues 150 based at least in part on the plurality of estimated phase differences 134. The plurality of estimated phase differences 134 are isomorphic to the plurality of eigenvalues of the unitary matrix 30, since eigenvalues of unitary matrices are located on the complex unit circle. Thus, the quantum computing device 12 and the processor 22 may compute a plurality of estimated eigenvalues 150 up to a global phase at least in part by computing the plurality of estimated phase differences 134. The processor 22 further outputs the estimated eigenvalues 150.

Using the techniques discussed above with reference to FIGS. 4-6, each of the estimated eigenphases \hat{θ} included in a set of estimated eigenphases \hat{Θ}⊂[0,2π) may be computed. The set of estimated eigenphases \hat{Θ} approximates the set of eigenphases Θ of the unitary matrix 30. d eigenphases θ are included in Θ. The quantum computing device 12 and the processor 22 may estimate each of the eigenphases θ in O(d log d) computations of respective estimated phase differences 134. The set of estimated eigenphases \hat{Θ} may differ from the set of eigenphases Θ by a distance measure d_{\tilde{H}}(Θ, \hat{Θ})≤ε defined as follows for two finite sets of eigenphases Θ₁,Θ₂⊂[0,2π):

$${d}_{\tilde{H}} ( {Θ}_{1} , {Θ}_{2} ) = {min}_{τ ∈ [ 0 , 2 π )} {d}_{H} ( {Θ}_{1} + τ , {Θ}_{2} )$$

In the above equation for the distance measure, d_{H} is the Hausdorff distance in [symbol] /2π [symbol] . The set of estimated eigenphases \hat{Θ} satisfies this error bound with a probability of at least 1−δ, where δ=d^{-C} for some large positive constant C. For example, C=100 may be used.

The eigenvalue estimation techniques discussed above may allow the computing system 10 to compute the plurality of estimated eigenvalues 150 with a sample complexity of O(d/ε)·log² d applications of the unitary matrix U.

With the techniques discussed above, the eigenvalues of a unitary matrix 30 may be estimated in a manner that does not require the inverse of the unitary matrix 30 or a controlled version of the unitary matrix 30. In some examples, the techniques discussed above for computing the estimated eigenvalues 150 may be used as a substitute for conventional quantum phase estimation when a controlled U gate is unavailable. In such examples, the processor 22 outputs the estimated eigenvalues 150 to a quantum phase estimation process 152. Quantum phase estimation is used as a subroutine of several quantum algorithms, including Shor's algorithm and the quantum algorithm for solving systems of linear equations. Thus, the eigenvalue estimation techniques discussed above may allow such quantum algorithms to be performed on a wider range of quantum computing device architectures due to not requiring a controlled U or a U⁻¹ gate.

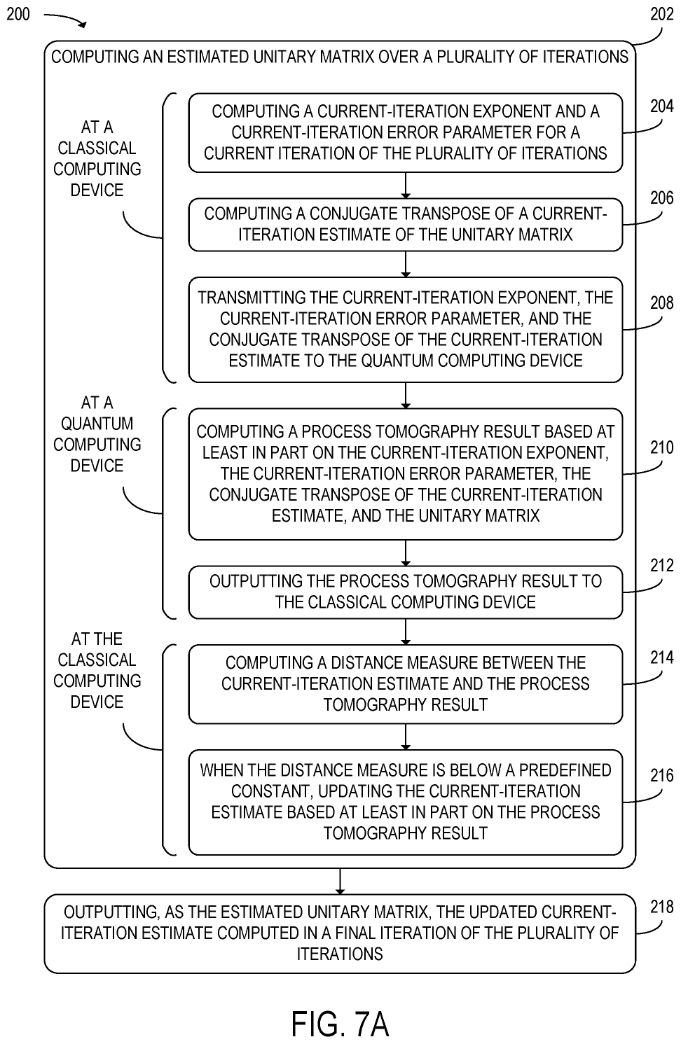

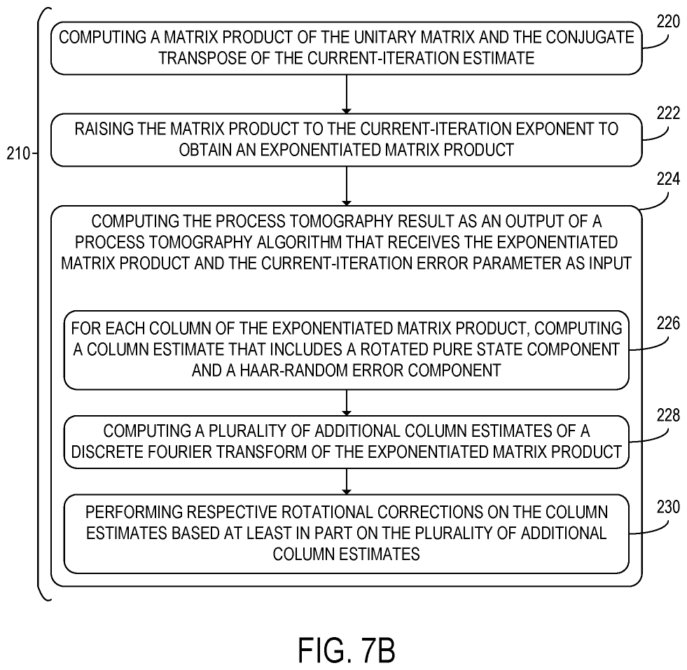

FIG. 7A shows a flowchart of a method 200 for use with a computing system including a quantum computing device and a classical computing device. The method 200 may be used with the computing system 10 of FIG. 1 or with some other computing system. As shown in FIG. 7A, the method 200 includes, at step 202, computing an estimated unitary matrix over a plurality of iterations. The estimated unitary matrix is an estimate of a unitary matrix implemented at a quantum circuit included in the quantum computing device. For example, the unitary matrix may be approximated in order to test whether the quantum circuit is performing as intended. FIG. 7A further shows the steps performed in each of the plurality of iterations during computation of the estimated unitary matrix. Each of the iterations includes steps performed at the classical computing device and steps performed at the quantum computing device. Steps 204, 206, 208, 214, and 216 are performed at the classical computing device and steps 210 and 212 are performed at the quantum computing device.

A total number of the plurality of iterations included in step 202 may, in some examples, be computed based at least in part on a first predefined error parameter ε. The total number of iterations may, for example, be computed as n=┌log₂(1/ε)┐. The first predefined error parameter may, for example, be received at the processor along with a second predefined error parameter δ as an input to the method 200.

At step 204, each of the iterations may include computing a current-iteration exponent and a current-iteration error parameter for a current iteration of the plurality of iterations. The current-iteration exponent and the current-iteration error parameter may, for example, be computed based at least in part on an iteration number of the current iteration. In such examples, for the jth iteration, the current-iteration exponent pⱼ may be computed as 2^{j}. In addition, the current-iteration error parameter δⱼ may be computed as δ8^{j-n-1}, where δ is the second predefined error parameter and n is the total number of iterations.

At step 206, the method 200 further includes computing a conjugate transpose of a current-iteration estimate of the unitary matrix. The current-iteration estimate of the unitary matrix may be initialized as an identity matrix in the first iteration of the plurality of iterations. The current-iteration estimate may subsequently be iteratively updated. At step 208, the method 200 further includes transmitting the current-iteration exponent, the current-iteration error parameter, and the conjugate transpose of the current-iteration estimate to the quantum computing device.

At step 210, the method 200 further includes, at the quantum computing device, computing a process tomography result based at least in part on the current-iteration exponent, the current-iteration error parameter, the conjugate transpose of the current-iteration estimate, and the unitary matrix. The steps by which the process tomography result may be computed, according to some examples, are discussed in further detail below with reference to FIG. 7B. At step 212, the method 200 further includes outputting the process tomography result to the classical computing device.

At step 214, the method 200 further includes, at the classical computing device, computing a distance measure between the current-iteration estimate and the process tomography result. The distance measure may, for example, be computed as the infimum of the lengths of all smooth paths connecting the current-iteration estimate and the process tomography result. In other examples, the distance measure may be computed as some other matrix norm.

At step 216, when the distance measure is below a predefined constant, the method 200 further includes updating the current-iteration estimate based at least in part on the process tomography result. When the distance measure is above the predefined constant in an iteration, the current-iteration estimate may be left unchanged in that iteration. The predefined constant may, for example, be ⅓π. In some examples, when the distance measure is below the predefined constant, updating the current-iteration estimate includes multiplying the current-iteration estimate by a current-iteration-exponent root of the process tomography result.

At step 218, subsequently to performing the plurality of iterations at step 202, the method 200 further includes outputting, as the estimated unitary matrix, the updated current-iteration estimate computed in a final iteration of the plurality of iterations. For example, the estimated unitary matrix may be output to a quantum circuit performance testing process.

FIG. 7B shows additional steps of the method 200 that may be performed when the process tomography result is computed at step 210. At step 220, step 210 may include computing a matrix product of the unitary matrix and the conjugate transpose of the current-iteration estimate. At step 222, step 210 may further include raising the matrix product to the current-iteration exponent to obtain an exponentiated matrix product.

At step 224, step 210 may further include computing the process tomography result as an output of a process tomography algorithm that receives the exponentiated matrix product and the current-iteration error parameter as input. The process tomography result may be computed as Uⱼ=A ((ZVⱼ^{†})^{p}^{ⱼ}, δⱼ) where A is the process tomography algorithm, Z is the unitary matrix, and Vⱼ^{†} is the conjugate transpose of the current-iteration estimate.

Steps 226, 228, and 230 show additional steps of the method 200 that may be performed when the process tomography algorithm is executed at step 224. At step 226, step 224 may include for each column of the exponentiated matrix product, computing a column estimate that includes a rotated pure state component and a Haar-random error component. At step 228, step 224 may further include computing a plurality of additional column estimates of a discrete Fourier transform of the exponentiated matrix product. In some examples, a Hadamard transform may be used instead of a Fourier transform. At step 230, step 224 may further include performing respective rotational corrections on the column estimates based at least in part on the plurality of additional column estimates. Performing the rotational corrections may, for example, include computing a diagonal unitary matrix by which a matrix of the column estimates may be multiplied to apply rotations to the column estimates. Steps 226 and 228 may be performed at the quantum computing device. Step 230 may include operations performed at the quantum computing device and operations performed at the classical computing device.

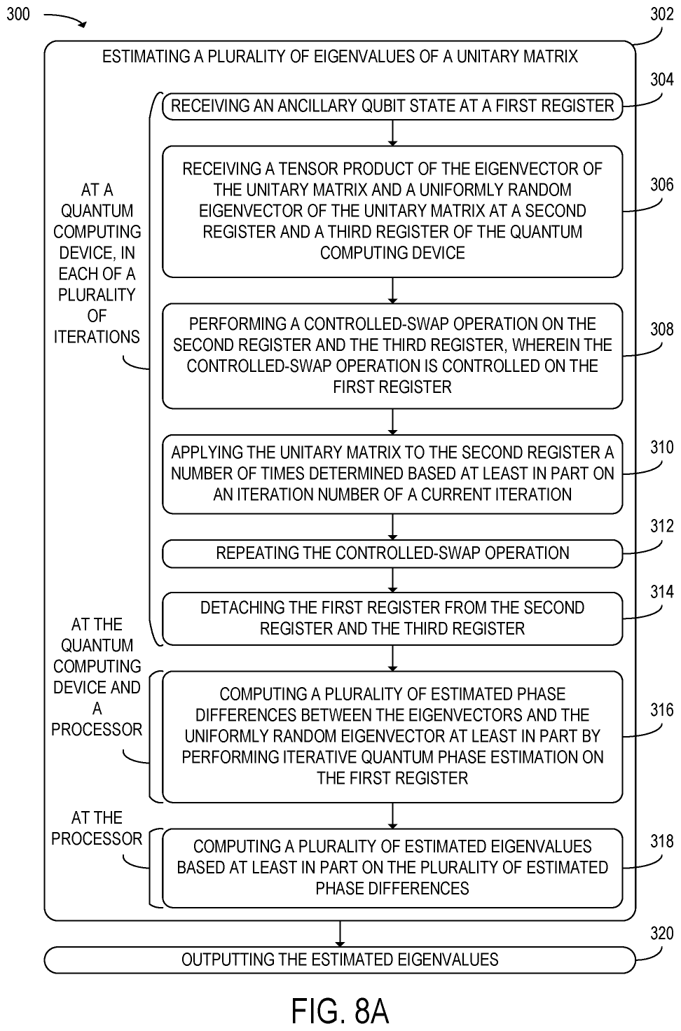

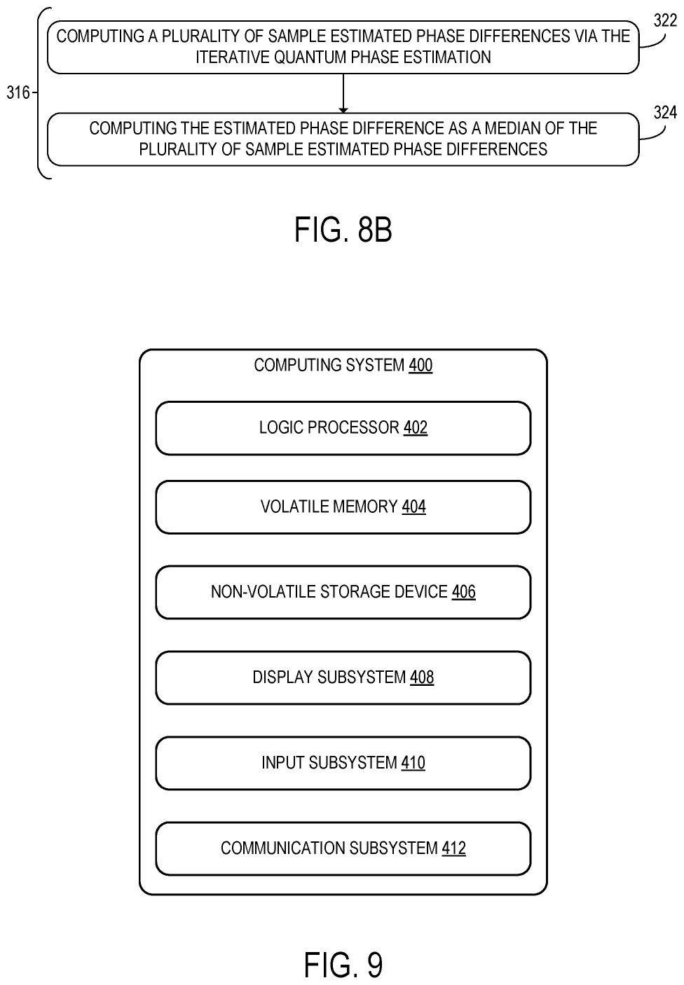

FIG. 8A shows a flowchart of another method 300 for use with a computing system including a quantum computing device and a classical computing device. The method 300 includes, at step 302, estimating a plurality of eigenvalues of a unitary matrix. Step 302 includes steps that are performed for each of a plurality of eigenvectors of the unitary matrix that are received as input to the method 300. The eigenvalues estimated at step 302 are respectively associated with the plurality of eigenvectors. Step 302 includes steps 304, 306, 308, 310, 312, and 314 which are performed at the quantum computing device in each of a plurality of iterations. In addition, step 302 includes step 316, which is performed at the quantum computing device and a processor of the classical computing device, and step 318, which is performed at the processor.

At step 304, step 302 includes receiving an ancillary qubit state at a first register of the quantum computing device. In addition, at step 306, step 302 further includes receiving a tensor product of the eigenvector of the unitary matrix and a uniformly random eigenvector of the unitary matrix. The tensor product is received at a second register and a third register of the quantum computing device. Thus, the second register and the third register are entangled when the tensor product is stored.

At step 308, step 302 further includes performing a controlled-SWAP operation on the second register and the third register. The controlled-SWAP operation is controlled on the first register. At step 310, step 302 further includes applying the unitary matrix to the second register a number of times determined based at least in part on an iteration number of a current iteration. The number of times the unitary matrix is applied to the second register may, for example, be equal to two to the power of the iteration number. At step 312, step 302 further includes repeating the controlled-SWAP operation on the second register and the third register, controlled on the first register.

At step 314, step 302 further includes detaching the first register from the second register and the third register. Subsequently to detaching the first register from the second register and the third register, the second register and the third register may store the tensor product of the eigenvector and the uniformly random eigenvector.

At step 316, step 302 further includes computing a plurality of estimated phase differences between the eigenvectors and the uniformly random eigenvector. The plurality of estimated phase differences are computed at least in part by performing iterative quantum phase estimation on the first register. When iterative quantum phase estimation is performed on the first register, a plurality of first register measurement results may be transmitted from the quantum computing device to the processor. The first register measurement results may form the bits of the estimated phase differences. Each of the estimated phase differences may be a difference between the angle on the complex unit circle of the eigenvalue of the uniformly random eigenvector and the angle on the complex unit circle of the eigenvalue associated with the eigenvector for which the current iteration is performed.

At step 318, step 302 further includes computing a plurality of estimated eigenvalues based at least in part on the plurality of estimated phase differences. The plurality of eigenvalues of the unitary matrix may be estimated up to a global phase.

At step 320, subsequently to estimating the plurality of eigenvalues at step 302, the method 300 further includes outputting the estimated eigenvalues. In some examples, the estimated eigenvalues are output to a quantum phase estimation process. Thus, the computing system may perform quantum phase estimation using the method 300 without requiring an inverse or controlled version of the unitary matrix.

FIG. 8B shows additional steps of the method 300 that may be performed in some examples. The steps shown in FIG. 8B may be performed when computing the plurality of estimated phase differences at step 316. At step 322, step 316 may further include computing a plurality of sample estimated phase differences via the iterative quantum phase estimation. At step 324, step 316 may further include computing the estimated phase difference as a median of the plurality of sample estimated phase differences. Thus, by sampling the estimated phase differences a plurality of times, the computing system may compute more accurate estimates of the eigenvalues of the unitary matrix.

Using the systems and methods discussed above, a unitary matrix implemented at a quantum computing device may be estimated to within user-specified error bounds. The estimated unitary matrix may be computed with a sample complexity of O(d²/ε). In contrast to previous approaches that require controlled and inverse versions of the unitary matrix to achieve a sample complexity of O(d²/ε), the systems and methods discussed above allow the unitary matrix to be estimated with the above sample complexity without requiring the ability to apply a controlled or inverse version of the unitary matrix.

The systems and methods discussed above further allow the eigenvalues of the unitary matrix to be estimated from the unitary matrix and its eigenvectors. The estimated eigenvalues may be computed without requiring a controlled or inverse version of the unitary matrix. In addition, the eigenvalues may be estimated with a sample complexity of O(d/ε)·log² d, which previous eigenvalue estimation approaches require controlled and inverse versions of the unitary matrix to achieve.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 400 that can enact one or more of the methods and processes described above. Computing system 400 is shown in simplified form. Computing system 400 may embody the computing system 10 described above and illustrated in FIG. 1. Components of computing system 400 be instantiated in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 400 includes a logic processor 402 volatile memory 404, and a non-volatile storage device 406. Computing system 400 may optionally include a display subsystem 408, input subsystem 410, communication subsystem 412, and/or other components not shown in FIG. 9.

Logic processor 402 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 402 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 406 includes one or more physical devices configured to hold instructions executable by the logic processors to implement the methods and processes described herein. When such methods and processes are implemented, the state of non-volatile storage device 406 may be transformed—e.g., to hold different data.

Non-volatile storage device 406 may include physical devices that are removable and/or built-in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by logic processor 402 to temporarily store information during processing of software instructions. It will be appreciated that volatile memory 404 typically does not continue to store instructions when power is cut to the volatile memory 404.

Aspects of logic processor 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via logic processor 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with logic processor 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 400 to send and/or receive messages to and/or from other devices via a network such as the Internet.

The following paragraphs discuss several aspects of the present disclosure. According to one aspect of the present disclosure, a computing system is provided, including a quantum computing device. The computing system further includes a classical computing device including a processor. The computing system computes an estimated unitary matrix over a plurality of iterations that each include, at the processor, computing a current-iteration exponent and a current-iteration error parameter for a current iteration of the plurality of iterations. Each iteration further includes computing a conjugate transpose of a current-iteration estimate of the unitary matrix. Each iteration further includes transmitting the current-iteration exponent, the current-iteration error parameter, and the conjugate transpose of the current-iteration estimate to the quantum computing device. At the quantum computing device, each iteration further includes computing a process tomography result based at least in part on the current-iteration exponent, the current-iteration error parameter, the conjugate transpose of the current-iteration estimate, and the unitary matrix. Each iteration further includes outputting the process tomography result to the classical computing device. At the processor, each iteration further includes computing a distance measure between the current-iteration estimate and the process tomography result. When the distance measure is below a predefined constant, the iteration further includes updating the current-iteration estimate based at least in part on the process tomography result. The computing system outputs, as the estimated unitary matrix, the updated current-iteration estimate computed in a final iteration of the plurality of iterations. The above features may have the technical effect of generating an estimate of the unitary matrix in a sample-efficient manner without requiring a controlled or inverse version of the unitary matrix.

According to this aspect, computing the process tomography result at the quantum computing device may include computing a matrix product of the unitary matrix and the conjugate transpose of the current-iteration estimate. Computing the process tomography result may further include raising the matrix product to the current-iteration exponent to obtain an exponentiated matrix product. Computing the process tomography result may further include computing the process tomography result as an output of a process tomography algorithm that receives the exponentiated matrix product and the current-iteration error parameter as input. The above features may have the technical effect of computing a process tomography result with a dependence upon the unitary matrix.

According to this aspect, the process tomography algorithm may include, for each column of the exponentiated matrix product, computing a column estimate that includes a rotated pure state component and a Haar-random error component. The above features may have the technical effect of generating the columns of the process tomography result.

According to this aspect, the process tomography algorithm may further include computing a plurality of additional column estimates of a discrete Fourier transform of the exponentiated matrix product. The process tomography algorithm may further include performing respective rotational corrections on the column estimates based at least in part on the plurality of additional column estimates. The above features may have the technical effect of correcting for rotations of the column estimates generated when computing the process tomography result.

According to this aspect, a total number of the plurality of iterations may be computed based at least in part on a first predefined error parameter. The above features may have the technical effect of selecting a number of iterations that allows the unitary matrix to be estimated to within a specified error bound.

According to this aspect, the current-iteration exponent and the current-iteration error parameter may be computed based at least in part on an iteration number of the current iteration. The above features may have the technical effect of iteratively updating variables that are used when computing the current-iteration estimate.

According to this aspect, the current-iteration exponent may be computed as two to the power of the iteration number of the current iteration. The above features may have the technical effect of iteratively updating the current-iteration exponent that is used when computing the current-iteration estimate.

According to this aspect, the current-iteration error parameter may be computed as a product of a second predefined error parameter and an exponential factor computed based at least in part on the iteration number and a total number of the plurality of iterations. The above features may have the technical effect of iteratively updating the current-iteration error parameter that is used when computing the current-iteration estimate.

According to this aspect, when the distance measure is below the predefined constant, updating the current-iteration estimate may include multiplying the current-iteration estimate by a current-iteration-exponent root of the process tomography result. The above features may have the technical effect of generating the current-iteration exponent using the process tomography result.

According to this aspect, the estimated unitary matrix may be output to a quantum circuit performance testing process. The above features may have the technical effect of allowing the estimated unitary matrix to be used to test whether a quantum circuit that implements the estimated unitary matrix exhibits its expected behavior.

According to another aspect of the present disclosure, a method for use with a computing system including a quantum computing device and a classical computing device is provided. The method includes computing an estimated unitary matrix over a plurality of iterations that each include, at the classical computing device, computing a current-iteration exponent and a current-iteration error parameter for a current iteration of the plurality of iterations. Each iteration further includes computing a conjugate transpose of a current-iteration estimate of the unitary matrix. Each iteration further includes transmitting the current-iteration exponent, the current-iteration error parameter, and the conjugate transpose of the current-iteration estimate to the quantum computing device. At the quantum computing device, each iteration further includes computing a process tomography result based at least in part on the current-iteration exponent, the current-iteration error parameter, the conjugate transpose of the current-iteration estimate, and the unitary matrix. Each iteration further includes outputting the process tomography result to the classical computing device. At the classical computing device, each iteration further includes computing a distance measure between the current-iteration estimate and the process tomography result. When the distance measure is below a predefined constant, the iteration further includes updating the current-iteration estimate based at least in part on the process tomography result. The method further includes outputting, as the estimated unitary matrix, the updated current-iteration estimate computed in a final iteration of the plurality of iterations. The above features may have the technical effect of generating an estimate of the unitary matrix in a sample-efficient manner without requiring a controlled or inverse version of the unitary matrix.

According to this aspect, computing the process tomography result may include, at the quantum computing device, computing a matrix product of the unitary matrix and the conjugate transpose of the current-iteration estimate. Computing the process tomography result may further include raising the matrix product to the current-iteration exponent to obtain an exponentiated matrix product. Computing the process tomography result may further include computing the process tomography result as an output of a process tomography algorithm that receives the exponentiated matrix product and the current-iteration error parameter as input. The above features may have the technical effect of computing a process tomography result with a dependence upon the unitary matrix.

According to this aspect, a total number of the plurality of iterations may be computed based at least in part on a first predefined error parameter. The above features may have the technical effect of selecting a number of iterations that allows the unitary matrix to be estimated to within a specified error bound.

According to this aspect, the current-iteration exponent and the current-iteration error parameter may be computed based at least in part on an iteration number of the current iteration. The above features may have the technical effect of iteratively updating variables that are used when computing the current-iteration estimate.

According to this aspect, when the distance measure is below the predefined constant, updating the current-iteration estimate may include multiplying the current-iteration estimate by a current-iteration-exponent root of the process tomography result. The above features may have the technical effect of generating the current-iteration exponent using the process tomography result.

According to another aspect of the present disclosure, a computing system is provided, including a quantum computing device. The computing system further includes a classical computing device including a processor. The computing system estimates a plurality of eigenvalues of the unitary matrix at least in part by, for each of a plurality of eigenvectors of the unitary matrix, at the quantum computing device, in each of a plurality of iterations, receiving an ancillary qubit state at a first register. Each of the plurality of iterations further includes receiving a tensor product of the eigenvector of the unitary matrix and a uniformly random eigenvector of the unitary matrix at a second register and a third register of the quantum computing device. Each of the plurality of iterations further includes performing a controlled-SWAP operation on the second register and the third register. The controlled-SWAP operation is controlled on the first register. Each of the plurality of iterations further includes applying the unitary matrix to the second register a number of times determined based at least in part on an iteration number of a current iteration. Each of the plurality of iterations further includes repeating the controlled-SWAP operation. Each of the plurality of iterations further includes detaching the first register from the second register and the third register. At the quantum computing device and the processor, estimating the plurality of eigenvalues further includes computing a plurality of estimated phase differences between the eigenvectors and the uniformly random eigenvector at least in part by performing iterative quantum phase estimation on the first register. At the processor, a plurality of estimated eigenvalues are computed based at least in part on the plurality of estimated phase differences. The computing system further outputs the estimated eigenvalues. The above features may have the technical effect of efficiently estimating the eigenvalues of the unitary matrix without requiring a controlled or inverse version of the unitary matrix.

According to this aspect, the number of times the unitary matrix is applied to the second register may be equal to two to the power of the iteration number. The above features may have the technical effect of iteratively updating the state of the second register when performing the plurality of iterations.

According to this aspect, when computing the estimated phase difference associated with an eigenvector of the plurality of eigenvectors, the computing system may further compute a plurality of sample estimated phase differences via the iterative quantum phase estimation. The computing system may compute the estimated phase difference as a median of the plurality of sample estimated phase differences. The above features may have the technical effect of computing more accurate estimates of the eigenvalues.

According to this aspect, subsequently to detaching the first register from the second register and the third register, the second register and the third register may store the tensor product of the eigenvector and the uniformly random eigenvector. The above features may have the technical effect of allowing the tensor product to be reused in a subsequent iteration.

According to this aspect, the estimated eigenvalues may be output to a quantum phase estimation process. The above features may have the technical effect of allowing quantum phase estimation to be performed without a controlled or inverse version of the unitary matrix.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
a quantum computing device; and
a classical computing device including a processor, wherein the computing system:
computes an estimated unitary matrix over a plurality of iterations that each include:
at the processor:
computing a current-iteration exponent and a current-iteration error parameter for a current iteration of the plurality of iterations;
computing a conjugate transpose of a current-iteration estimate of the unitary matrix; and
transmitting the current-iteration exponent, the current-iteration error parameter, and the conjugate transpose of the current-iteration estimate to the quantum computing device;
at the quantum computing device:
computing a process tomography result based at least in part on the current-iteration exponent, the current-iteration error parameter, the conjugate transpose of the current-iteration estimate, and the unitary matrix; and
outputting the process tomography result to the classical computing device; and
at the processor:
computing a distance measure between the current-iteration estimate and the process tomography result; and
when the distance measure is below a predefined constant, updating the current-iteration estimate based at least in part on the process tomography result; and
outputs, as the estimated unitary matrix, the updated current-iteration estimate computed in a final iteration of the plurality of iterations.

2. The computing system of claim 1, wherein, at the quantum computing device, computing the process tomography result includes:
computing a matrix product of the unitary matrix and the conjugate transpose of the current-iteration estimate;
raising the matrix product to the current-iteration exponent to obtain an exponentiated matrix product; and
computing the process tomography result as an output of a process tomography algorithm that receives the exponentiated matrix product and the current-iteration error parameter as input.

3. The computing system of claim 2, wherein the process tomography algorithm includes, for each column of the exponentiated matrix product, computing a column estimate that includes a rotated pure state component and a Haar-random error component.

4. The computing system of claim 3, wherein the process tomography algorithm further includes:
computing a plurality of additional column estimates of a discrete Fourier transform of the exponentiated matrix product; and
performing respective rotational corrections on the column estimates based at least in part on the plurality of additional column estimates.

5. The computing system of claim 1, wherein a total number of the plurality of iterations is computed based at least in part on a first predefined error parameter.

6. The computing system of claim 1, wherein the current-iteration exponent and the current-iteration error parameter are computed based at least in part on an iteration number of the current iteration.

7. The computing system of claim 6, wherein the current-iteration exponent is computed as two to the power of the iteration number of the current iteration.

8. The computing system of claim 6, wherein the current-iteration error parameter is computed as a product of:
a second predefined error parameter; and
an exponential factor computed based at least in part on the iteration number and a total number of the plurality of iterations.

9. The computing system of claim 1, wherein, when the distance measure is below the predefined constant, updating the current-iteration estimate includes multiplying the current-iteration estimate by a current-iteration-exponent root of the process tomography result.

10. The computing system of claim 1, wherein the estimated unitary matrix is output to a quantum circuit performance testing process.

11. A method for use with a computing system including a quantum computing device and a classical computing device, the method comprising:
computing an estimated unitary matrix over a plurality of iterations that each include:
at the classical computing device:
computing a current-iteration exponent and a current-iteration error parameter for a current iteration of the plurality of iterations;
computing a conjugate transpose of a current-iteration estimate of the unitary matrix; and
transmitting the current-iteration exponent, the current-iteration error parameter, and the conjugate transpose of the current-iteration estimate to the quantum computing device;
at the quantum computing device:
computing a process tomography result based at least in part on the current-iteration exponent, the current-iteration error parameter, the conjugate transpose of the current-iteration estimate, and the unitary matrix; and
outputting the process tomography result to the classical computing device; and
at the classical computing device:
computing a distance measure between the current-iteration estimate and the process tomography result; and
when the distance measure is below a predefined constant, updating the current-iteration estimate based at least in part on the process tomography result; and
outputting, as the estimated unitary matrix, the updated current-iteration estimate computed in a final iteration of the plurality of iterations.

12. The method of claim 11, wherein, at the quantum computing device, computing the process tomography result includes:
computing a matrix product of the unitary matrix and the conjugate transpose of the current-iteration estimate;
raising the matrix product to the current-iteration exponent to obtain an exponentiated matrix product; and
computing the process tomography result as an output of a process tomography algorithm that receives the exponentiated matrix product and the current-iteration error parameter as input.

13. The method of claim 11, wherein a total number of the plurality of iterations is computed based at least in part on a first predefined error parameter.

14. The method of claim 11, wherein the current-iteration exponent and the current-iteration error parameter are computed based at least in part on an iteration number of the current iteration.

15. The method of claim 11, wherein, when the distance measure is below the predefined constant, updating the current-iteration estimate includes multiplying the current-iteration estimate by a current-iteration-exponent root of the process tomography result.

16. A computing system comprising:
a quantum computing device; and
a classical computing device including a processor, wherein the computing system:
estimates a plurality of eigenvalues of the unitary matrix at least in part by, for each of a plurality of eigenvectors of the unitary matrix:
at the quantum computing device, in each of a plurality of iterations:
receiving an ancillary qubit state at a first register;
receiving a tensor product of the eigenvector of the unitary matrix and a uniformly random eigenvector of the unitary matrix at a second register and a third register of the quantum computing device;
performing a controlled-SWAP operation on the second register and the third register, wherein the controlled-SWAP operation is controlled on the first register;
applying the unitary matrix to the second register a number of times determined based at least in part on an iteration number of a current iteration;
repeating the controlled-SWAP operation; and
detaching the first register from the second register and the third register;
at the quantum computing device and the processor, computing a plurality of estimated phase differences between the eigenvectors and the uniformly random eigenvector at least in part by performing iterative quantum phase estimation on the first register; and
at the processor, computing a plurality of estimated eigenvalues based at least in part on the plurality of estimated phase differences; and
outputs the estimated eigenvalues.

17. The computing system of claim 16, wherein the number of times the unitary matrix is applied to the second register is equal to two to the power of the iteration number.

18. The computing system of claim 16, wherein, when computing the estimated phase difference associated with an eigenvector of the plurality of eigenvectors, the computing system further:
computes a plurality of sample estimated phase differences via the iterative quantum phase estimation; and
computes the estimated phase difference as a median of the plurality of sample estimated phase differences.

19. The computing system of claim 16, wherein, subsequently to detaching the first register from the second register and the third register, the second register and the third register store the tensor product of the eigenvector and the uniformly random eigenvector.

20. The computing system of claim 16, wherein the estimated eigenvalues are output to a quantum phase estimation process.
